(19) United States
(12) Patent Application Publication
(10) Pub. No.: US 2021/0133220 A1
(43) Pub. Date: May 6, 2021

(54) INFORMATION PROCESSING APPARATUS AND INFORMATION PROCESSING METHOD

(71) Applicant: SONY CORPORATION, Tokyo (JP)

(72) Inventors: Yusuke Sakai, Kanagawa (JP); Kiichi Kobayashi, Kanagawa (JP); Yosuke Seki, Kanagawa (JP); Kazutaka Ishizaki, Kanagawa (JP); Akira Tsutsumi, Kanagawa (JP); Ayako Tsushima, Kanagawa (JP)

(73) Assignee: SONY CORPORATION, Tokyo (JP)

(21) Appl. No.: 17/083,838

(22) Filed: Oct. 29, 2020

(30) Foreign Application Priority Data
Nov. 5, 2019 (JP) 2019-200680

(51) Int. Cl. G06F 16/29; G06F 16/22

(52) U.S. Cl. CPC G06F 16/29; G06F 3/1454; G06F 16/22

(57) ABSTRACT

Disclosed herein is an information processing apparatus including a specifying section that specifies a base map to be processed, and a registering section that associates annexed data annexed to the base map specified by the specifying section with information regarding the base map and registers the annexed data in a map database including a database that manages data regarding maps.

### CROSS REFERENCE TO RELATED APPLICATIONS

This application claims the benefit of Japanese Priority Patent Application JP 2019-200680 filed Nov. 5, 2019, the entire contents of which are incorporated herein by reference.

### BACKGROUND

The present disclosure relates to an information processing apparatus and an information processing method, and more particularly to an information processing apparatus and an information processing method that allow users at remote places to work easily together to produce a map.

Heretofore, there has been devised a telepresence system for enabling users at remote places to communicate with each other (see, for example, JP 2002-300602A).

### SUMMARY

It is conceivable to use such a telepresence system in a case where users at remote places work together to produce a map, for example. However, the existing telepresence system operates to only send and receive each other's images and speech. It has been desired in the art for the telepresence system to have a function to enable users to work more efficiently on the telepresence system.

The present disclosure has been made in view of the above background, and it is desirable to provide an information processing apparatus and an information processing method that allow users at remote places to work more easily together to produce a map.

An information processing apparatus according to an embodiment of the present technology includes a specifying section that specifies a base map to be processed, and a registering section that associates annexed data annexed to the base map specified by the specifying section with information regarding the base map and registers the annexed data in a map database including a database that manages data regarding maps.

An information processing method according to the embodiment of the present technology includes specifying a base map to be processed, and associating annexed data annexed to the base map that is specified with information regarding the base map and registering the annexed data in a map database including a database that manages data regarding maps.

An information processing apparatus according to another embodiment of the present technology includes a specifying section that specifies a base map to be processed, and a reading section that reads out annexed data annexed to the base map specified by the specifying section, from a map database including a database that manages data regarding maps.

An information processing method according to the other embodiment of the present technology includes specifying a base map to be processed, and reading out annexed data annexed to the base map that is specified, from a map database including a database that manages data regarding maps.

With the information processing apparatus and the information processing method according to the embodiment of the present technology, a base map to be processed is specified, and annexed data annexed to the base map that is specified is associated with information regarding the base map and registered in a map database that is a database that manages data regarding maps.

With the information processing apparatus and the information processing method according to the other embodiment of the present technology, a base map to be processed is specified, and annexed data annexed to the base map that is specified is read out from a map database that is a database that manages data regarding maps.

### BRIEF DESCRIPTION OF THE DRAWINGS

FIG. 1 is a view illustrating a general concept of a telepresence system;

FIG. 2 is a view illustrating an example of a process in which users work together to produce a map on the telepresence system;

FIG. 3 is a block diagram of a major configurational example of the telepresence system;

FIG. 4 is a perspective view illustrating an example of the appearance of a telepresence apparatus;

FIG. 5 is a perspective view illustrating another example of the appearance of the telepresence apparatus;

FIG. 6 is a block diagram of a major configurational example of the telepresence apparatus;

FIG. 7 is a functional block diagram of a major functional example realized by the telepresence apparatus;

FIG. 8 is a block diagram of a major configurational example of a server;

FIG. 9 is a functional block diagram of a major functional example realized by the server;

FIG. 10A and FIG. 10B are views illustrating a general concept of a base map and annexed data;

FIG. 11 is a diagram illustrating a major configurational example of data registered in a map database;

FIG. 12 is a flowchart of a processing sequence for registering annexed data;

FIG. 13 is a flowchart of a processing sequence for displaying annexed data;

FIG. 14 is a flowchart of a processing sequence for editing a map;

FIG. 15 is a view illustrating an example of a process in which users work together to produce a map;

FIG. 16 is a view illustrating an example of a process in which users work together to produce a map; and

FIG. 17 is a view illustrating an example of a process in which users work together to produce a map.

### DETAILED DESCRIPTION OF THE PREFERRED EMBODIMENTS

Modes for carrying out the present disclosure (hereinafter referred to as “embodiments”) will be described below. It is to be noted that the description will be given in the following sequence.

1. First embodiment (telepresence system)

2. Second embodiment (use case)

3. Appendix

### 1. First Embodiment

### Telepresence System

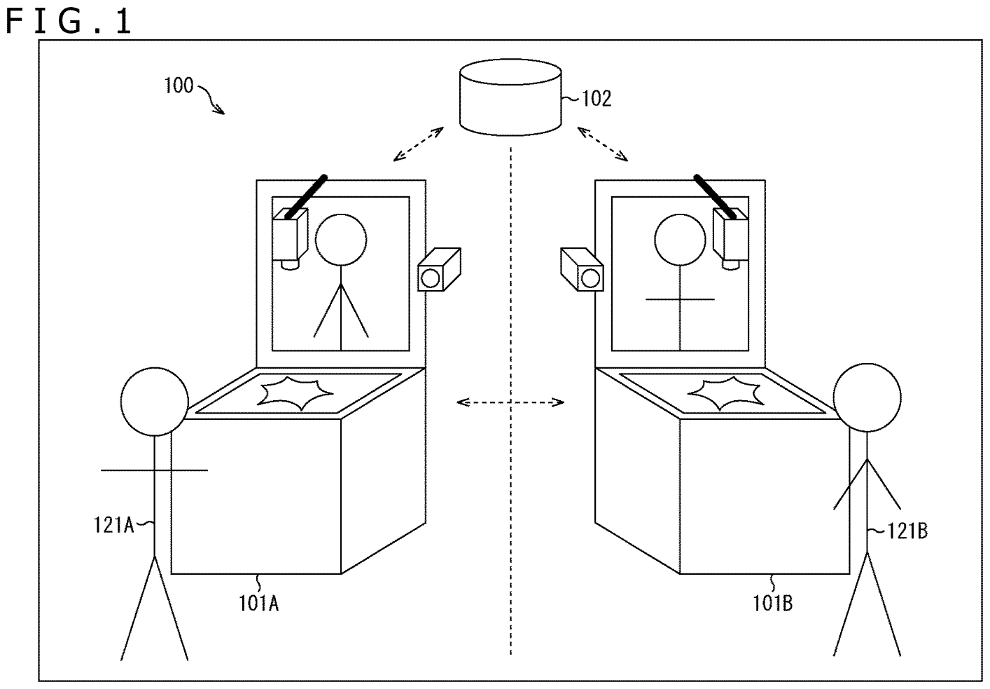

FIG. 1 illustrates a general concept of a telepresence system as a communication system (information processing system) according to a first embodiment of the present technology.

A telepresence system 100 is a communication system for users at remote places to communicate with each other. The telepresence system 100 has a plurality of telepresence apparatuses as terminal apparatuses. For example, in a case illustrated in FIG. 1, the telepresence system 100 has a telepresence apparatus 101A and a telepresence apparatus 101B.

The telepresence apparatus 101A is a terminal apparatus that is operated by a user 121A. The telepresence apparatus 101B is a terminal apparatus that is operated by a user 121B. The telepresence apparatus 101A and the telepresence apparatus 101B are disposed in places that are remote from each other.

In the present description, a remote place refers to a spot that is different from a certain reference spot. Spaces at multiple spots that are remote from each other shall be in respective states that are independent of each other. For example, each of the spaces at the respective spots shall partly or wholly be physically isolated or sufficiently spaced from the spaces at other spots by obstacles such as ceilings, floors, walls, or some objects (including telepresence apparatus themselves, for example). The users at the remote places shall communicate with each other through the telepresence system 100, not directly with voices, gestures, etc.

The telepresence apparatus 101A and the telepresence apparatus 101B can communicate with each other and can send, receive, and share various forms of information such as images or speech, for example, via their communication. Further, the telepresence apparatus 101A and the telepresence apparatus 101B can communicate with a server 102 and can communicate with each other through the server 102. For example, the telepresence apparatus 101A and the telepresence apparatus 101B can each supply any information to the server 102 such that the server 102 manages the information, and can acquire desirable information from the server 102.

In a case where the telepresence apparatus 101A and the telepresence apparatus 101B do not need to be described separately from each other below, they are referred to as a telepresence apparatus 101. In addition, in a case where the user 121A and the user 121B do not need to be referred to separately, they are referred to as a user 121.

It is to be noted that the number of telepresence apparatuses 101 included in the telepresence system 100 is determined as desired insofar as there is a plurality of telepresence apparatuses 101. The telepresence system 100 may have two telepresence apparatuses 101 as illustrated in FIG. 1 or may have three or more telepresence apparatuses 101. The number of servers 102 is also determined as desired, and the telepresence system 100 may have a plurality of servers.

The telepresence apparatus 101 at each spot includes a desktop area, and work done on the desktop area can be shared between the telepresence apparatuses 101.

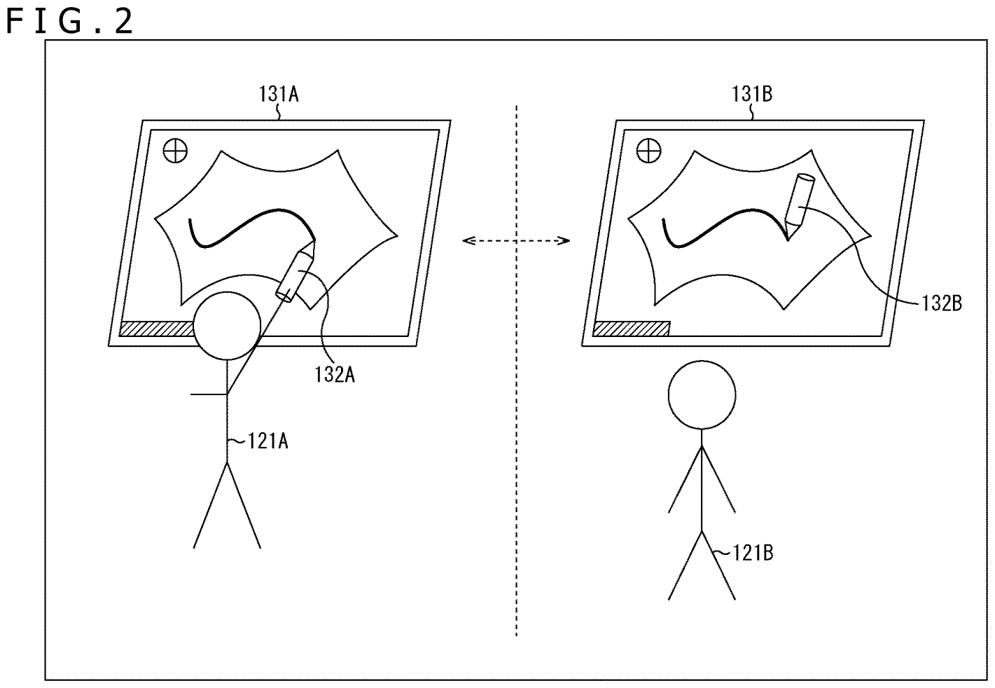

For example, as illustrated in FIG. 2, it is assumed that the user 121A operates a pen 132A to draw a curve on a base map 131A on the desktop area of the telepresence apparatus 101A. In this case, the curve is displayed overlappingly on a base map 131B placed on the desktop area of the telepresence apparatus 101B that is operated by the user 121B. It is to be noted that, at this time, a hypothetical pen 132B as it writes the curve may be displayed overlappingly on the base map 131B.

By thus sharing the desktop areas and sharing the contents of work, the users 121 in the remote places can work more efficiently together.

Using the telepresence system 100, for example, the remote users can share and confirm a map having a size and an amount of information large enough for an action to “open a map,” and optimally edit and output (produce) the map according to various situations and applications.

The “map” is available in various formats, e.g., those printed on paper and sold and distributed as booklets, atlases, or folding maps, those dynamically generated and presented as digital information by applications of a smartphone, a tablet, and a PC terminal, those expressed on a two-dimensional plane, those expressed as solid objects such as terrestrial globes or expressed in 3D spaces or in time sequences, etc. The telepresence system 100 deals with all map data having a base area that can be shared through the telepresence apparatuses 101 by their users.

Heretofore, the maps include not only those having general map information such as geographical features, roads, buildings, names, or addresses placed faithfully in real spaces but also those with various kinds of information annexed according to particular applications and purposes and those with various designs, such as hazard maps, route maps, sightseeing guide maps, mountain climbing route guide maps, antique maps, and bird's-eye views. Therefore, it is general practice to collect and organize a variety of information for map production.

The state of real spaces changes all the time due to changes in geometrical features, rebuilt buildings, newly created roads, etc. For creating a more accurate map, it may be necessary to have information to be inserted in the map incorporate such changes. In addition, in a case of maps for use in particular applications, it may need to incorporate changes in not only general map information but also information for the applications. Further, in order to create map information for a new purpose, new information for the purpose may be annexed or a new design may be applied.

The production of maps thus involves a large amount of work and a number of producers as various items of information may need to be frequently annexed, deleted, and/or updated. Further, since it may be necessary to collect information regarding real spaces and reflect it in the production of maps, as described above, the capability to produce maps in a variety of situations results in higher efficiency. Moreover, in the event of a natural disaster or the like, for example, it may be necessary to produce a map immediately on a real time basis for confirming safe routes and setting up evacuation routes according to the situation of the disaster.

Consequently, it has been required for a plurality of map producers present at respective locations remote from each other to be able to work together. However, as regards maps made of paper that are generally most practical in use, it is not easy to alter block copies that have been produced. Therefore, even if there is additional information that a user has written on a map, it has been difficult for the user to share the additional information with other users. It has also been difficult to integrate various items of information created by a group of users.

The telepresence system 100 described above allows users 121 at remote places to work more efficiently together by sharing desktop areas and contents of work. In other words, the telepresence system 100 can produce maps efficiently.

Inasmuch as maps are able to carry various kinds of information according to purposes, applications, etc., as described above, it is important to select useful information in the production of maps. However, it is difficult to appropriately manage various kinds of information and select useful information simply by sharing desktop areas and contents of work, and tedious and time-consuming work may be required to produce maps.

For example, there has been put to practical use a function to accumulate meta information linked to spots (building names, periphery photographs, related moving images, etc., corresponding to marks on a map) and to present the accumulated meta information on a map of digital data. However, as the meta information contains an excessively large amount of information that would tend to clutter the map if displayed in its entirety, a process of selectively displaying data lower than a certain density is performed. According to the process, for example, if a map area in a desirable range is selected, for example, then the names and information of certain spots to be presented in the map area may not be displayed, and if the area to be presented is enlarged to display desired information, then the overall map area may become invisible. At present, therefore, it is more difficult than can be imagined to produce maps on a digital information base that can satisfy performance requirements for dedicated paper-base maps.

Though 10-inch tablet terminals are available in wide use, there have not been present in the art portable digital terminals having display sizes of A1 and A2, and no process has been established for inputting detailed hand-written data using paper and a pen simultaneously. Accordingly, nothing but paper-base maps have to be used in a cooperative type of work to edit and produce maps by “opening a map.”

Therefore, it has been required in the art for users at remote places to be able to work more easily together to produce a map.

Therefore, a base map to be processed is specified, and annexed data annexed to the specified base map is associated with information regarding the base map and registered in a map database that is a database for managing data regarding maps.

For example, an information processing apparatus includes a specifying section that specifies a base map to be processed and a registering section that associates annexed data annexed to the base map specified by the specifying section with information regarding the base map and registers the associated annexed data in a map database that is a database for managing data regarding maps.

Further, for example, a base map to be processed is specified, and annexed data annexed to the specified base map are read out from a map database that is a database for managing data regarding maps.

For example, an information processing apparatus includes a specifying section that specifies a base map to be processed and a reading section that reads out annexed data annexed to the base map specified by the specifying section from a map database that is a database for managing data regarding maps.

With the above arrangements, users at remote places that are connected to each other can confirm, edit, and produce a map by working together comfortably and efficiently on a shared map data area as a base through the telepresence apparatus 101 by way of natural cognition, action, and communication as if the users were in the same space. Therefore, the users at the remote places are able to work together more easily to produce a map.

It is to be noted that the base map refers to a map as a block copy and is a basic map to which information (annexed data) is annexed according to its desired purpose and application in producing a map based on the desired purpose and application. The base map may be a map of non-digital data such as a paper map or may be a map of digital data (also referred to as map data), for example. The base map may contain any contents. In other words, a map containing any information may be used as a base map. The base map will hereinafter be described as a map where general map information such as geographical features, roads, buildings, names, or addresses is placed faithfully in a real space, for example.

For example, a user 121 can capture and recognize a paper map presented on the desktop area as the shared work space on its telepresence apparatus 101 at a certain location and can present its image and related meta information superposed thereon or linked thereto to a companion user 121. For recognition, a trigger such as identification (ID) information or a tag pattern in the map data is used and checked against the database.

Accordingly, using a dedicated paper map as a basis, multiple users present at respective places that are remote from each other can share the base map and annexed data recognized by the telepresence system 100 while confirming, editing, and producing a map naturally and comfortably with paper and pens. In addition, a complementary arrangement including digital paper terminals is also possible.

Further, annexed data annexed to the base map may include, for example, at least one of written data written on the base map, address information indicating the location of the written data, data of map information added to the base map, address information indicating the location of the data of the map information, data of updating information for updating information included in the base map, or address information indicating the location of the data of the updating information.

In addition, the annexed data may further include context information indicating a state at the time when the annexed data is created. Specifically, a process of editing a map may be recorded in linked relation to recognized context information such as states and situations of users who use the telepresence apparatuses 101. In this manner, multidimensional meta information can be annexed to the same base map.

For example, the context information may include at least one of information regarding the type of annexed data, information regarding the date and time of creation of the annexed data, information regarding the user who has created the annexed data, or information regarding the state at the time of creation of the annexed data.

By inputting particular application and purpose information of an area in a newly established map data area from a database (DB) constructed by such continuous, accumulative, and remotely cooperative work, it is possible to create a map optimum for the scene.

When a user shares a map on a common block copy base thus produced with another user 121 at a remote place through the telepresence apparatus 101, for example, the telepresence system 100 can recognize the base map in the desktop area, extract the base map and annexed data as meta information annexed by hand-writing or on a real time basis (immediately) multidimensionally together with state information of the user, and present these items of information to the other user (by way of a large-screen interactive display, projection mapping onto a paper-base map, augmented reality (AR) superposition, or the like).

The users can thus integrate the meta information annexed by them to the common map data, create a map optimized according to an application such as a “route map that can be used when moving on vehicles” or a “map of spots where water and food can be secured,” for example, and construct a more useful and effective map database by acquiring information on the basis of the map.

### Telepresence System Configuration

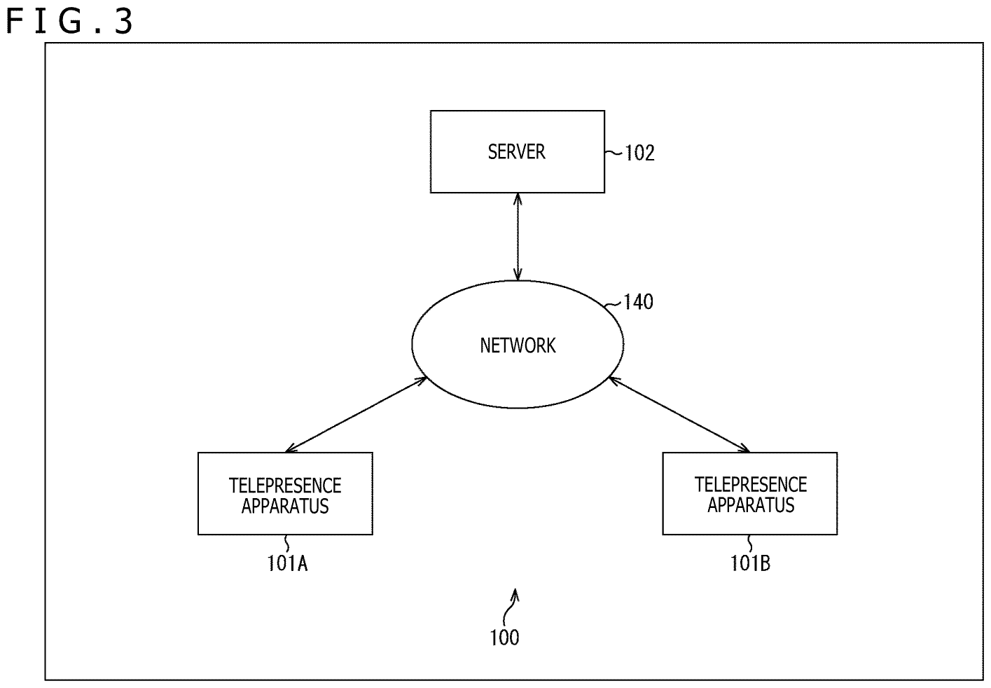

FIG. 3 illustrates, in block form, a major configurational example of the telepresence system 100. As illustrated in FIG. 3, the telepresence system 100 has a plurality of telepresence apparatuses 101 and the server 102.

In FIG. 3, the telepresence apparatus 101A and the telepresence apparatus 101B are illustrated. However, the number of the telepresence apparatuses 101 included in the telepresence system 100 is determined as desired, as long as there are two or more telepresence apparatuses 101. In other words, the telepresence system 100 may have three or more telepresence apparatuses 101.

The telepresence apparatuses 101 are disposed in respective places where communication is to take place (in remote places). The telepresence apparatus 101 and the server 102 are connected to each other by a network 140 such that they can communicate with each other.

The server 102 provides services for providing annexed data relative to a base map shared in communication between the telepresence apparatuses 101. More specifically, the server 102 manages annexed data created by the respective telepresence apparatuses 101.

The network 140 is a communication network including any communication medium. Communication performed through the network 140 may be wired communication, wireless communication, or both of them. In other words, the network 140 may be a communication network for wired communication, a communication network for wireless communication, or a communication network including both of those communication networks. Further, the network 140 may be a single communication network or a plurality of communication networks.

For example, the Internet may be included in the network 140. Further, a public telephone circuit network may be included in the network 140. In addition, a wide-area communication network for wireless mobile bodies, such as a 3G network or a 4G network, may be included in the network 140. A wide area network (WAN), a local area network (LAN), or the like may be included in the network 140. A wireless communication network for performing communication pursuant to the Bluetooth (registered trademark) standards may be included in the network 140. A communication channel for short-range wireless communication such as near field communication (NFC) may be included in the network 140. A communication channel for infrared radiation may be included in the network 140. A communication network for wired communication pursuant to the high-definition multimedia interface (HDMI) (registered trademark) standards, the universal serial bus (USB) (registered trademark) standards, or the like may be included in the network 140. The network 140 may include communication networks and communication channels according to any communication standard.

The telepresence apparatuses 101 and the server 102 are each connected to the network 140 by wired communications, wireless communications, or both of them.

### Appearance Example 1 of Telepresence Apparatus

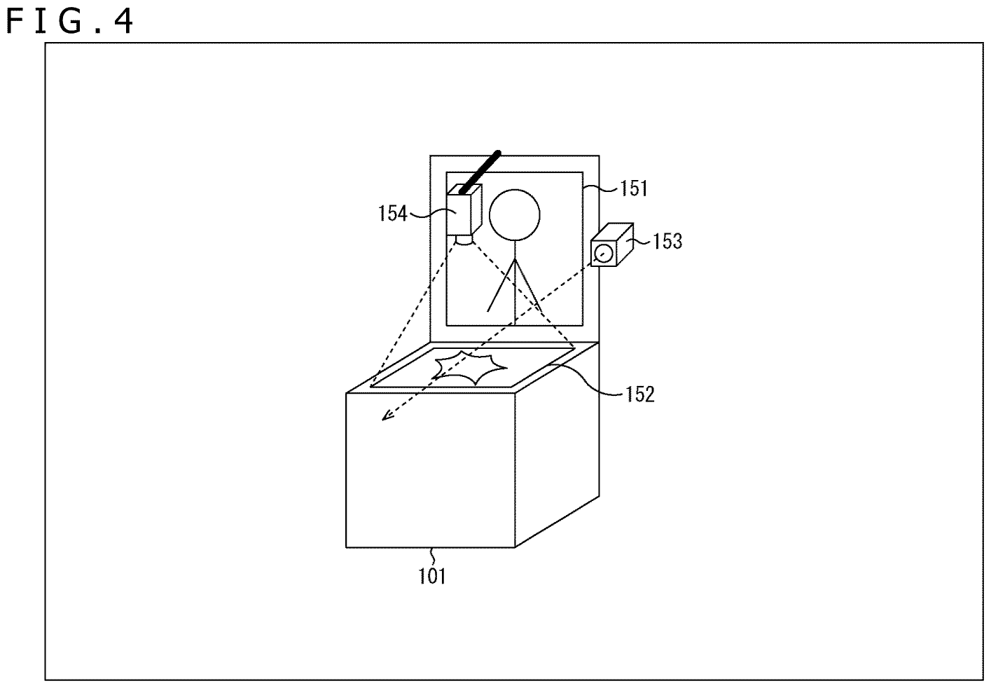

FIG. 4 illustrates an example of the appearance of the telepresence apparatus 101. As illustrated in FIG. 4, the telepresence apparatus 101 has a housing on which there are disposed a display 151, a desktop area 152, a camera 153, and a projection detector 154.

The display 151 displays a captured image of the space of a communication companion (referred to as a companion space). The desktop area 152 is an area where work contents are shared by the communication companion. The camera 153 is an image capturing unit configured to capture an image of the space where the telepresence apparatus 101 is installed (referred to as an own space). The projection detector 154 has a projector and various sensors. The projection detector 154 projects an image onto the desktop area 152 and detects work (such as updating of map data) done on the desktop area 152.

### Appearance Example 2 of Telepresence Apparatus

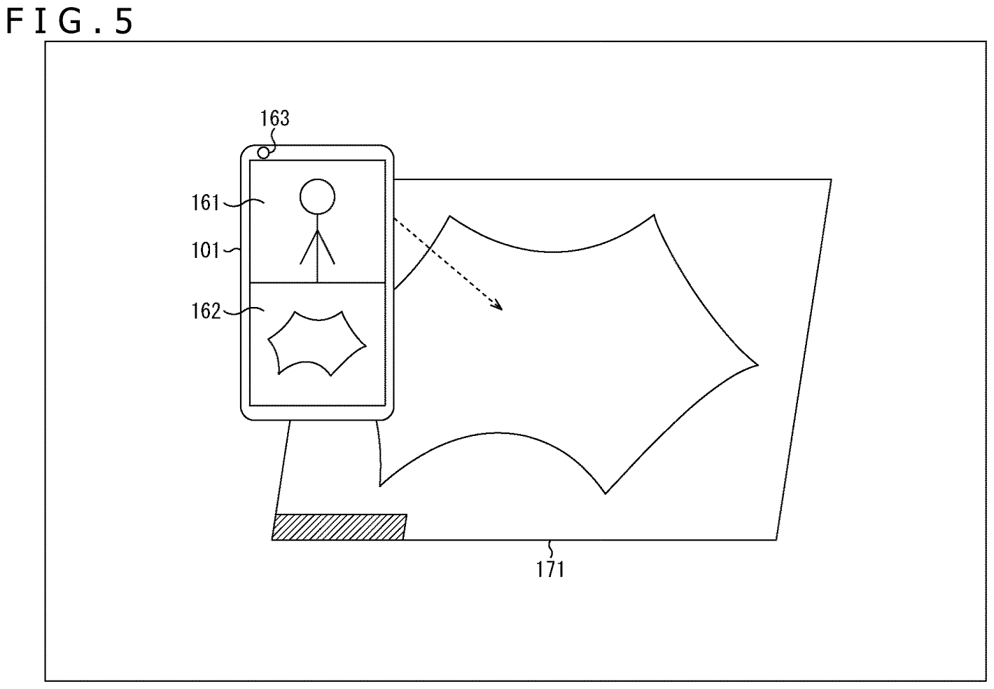

The appearance of the telepresence apparatus 101 is determined as desired and is not limited to the example illustrated in FIG. 4. For example, as illustrated in FIG. 5, the telepresence apparatus 101 may be realized by a portable information processing terminal device such as a smartphone.

In an outdoor environment, a smartphone terminal reads a paper map and written information to analyze the projection method, the geodetic system, coordinates, and the range of the map, and shares the data with remote users by integrating the data as digital information in a server.

In the example illustrated in FIG. 5, the telepresence apparatus 101 is realized by a smartphone having one display with a touch panel. In such a case, the telepresence apparatus 101 (the smartphone) divides the display with the touch panel into a communication companion display area 161 for displaying a captured image of a companion space and a desktop display area 162 for displaying a desktop area. In these display areas, the user can input information via the touch panel.

Further, the telepresence apparatus 101 (the smartphone) has a communication function that allows a captured image of a companion space sent from the telepresence apparatus 101 of the communication companion to be displayed on the display with the touch panel.

Moreover, the telepresence apparatus 101 (the smartphone) has a camera 163 on the same surface thereof as the display with the touch panel, for capturing an image of the space (own space) where the telepresence apparatus 101 (the smartphone) is positioned. The telepresence apparatus 101 (the smartphone) can send the captured image of the own space to the telepresence apparatus 101 of the communication companion via the communication function.

In addition, the telepresence apparatus 101 (the smartphone) has a camera (not illustrated) on a surface thereof that is opposite the surface where the display with the touch panel is provided, for capturing an image of a base map 171 of paper or the like. The telepresence apparatus 101 (the smartphone) can display the captured image in the desktop display area 162 of the display with the touch panel.

In other words, the telepresence apparatus 101 illustrated in FIG. 5 has basically similar functions to the telepresence apparatus 101 illustrated in FIG. 4.

### Configuration of Telepresence Apparatus

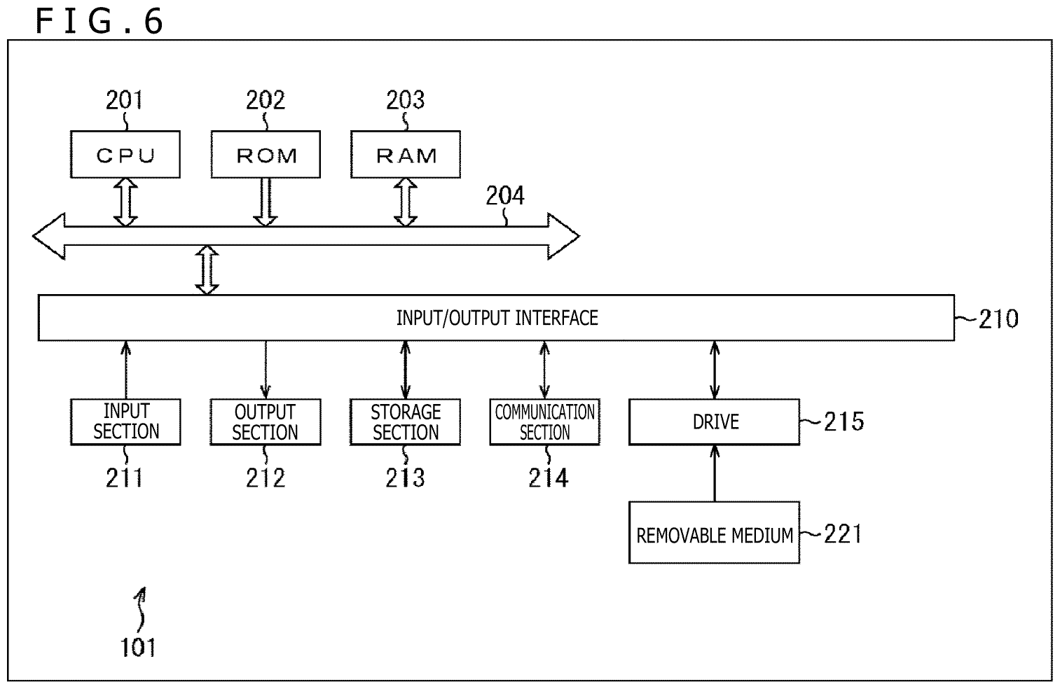

FIG. 6 illustrates, in block form, a major configurational example of the telepresence apparatus 101. In the telepresence apparatus 101 illustrated in FIG. 6, a central processing unit (CPU) 201, a read only memory (ROM) 202, and a random access memory (RAM) 203 are connected to each other by a bus 204.

An input/output interface 210 is connected to the bus 204. An input section 211, an output section 212, a storage section 213, a communication section 214, and a drive 215 are connected to the input/output interface 210.

The input section 211 can include any input device such as a keyboard, a mouse, a microphone, a touch panel, an image sensor, a motion sensor, and various other sensors, for example. The input section 211 may also include input terminals. The output section 212 can include any output device such as a display, a projector, or a speaker, for example. The output section 212 may also include output terminals.

The storage section 213 includes any storage medium such as a hard disk, a RAM disk, or a nonvolatile memory, for example, and a storage controller for writing information into and reading out information from the storage medium. The communication section 214 includes a network interface, for example. The drive 215 drives any removable medium 221 such as a magnetic disk, an optical disk, a magnetooptical disk, or a semiconductor memory to write information into and read out information from the removable medium 221.

In the telepresence apparatus 101 thus configured, the CPU 201 loads programs stored in the storage section 213 into the RAM 203 through the input/output interface 210 and the bus 204 and executes the loaded programs to realize various functions represented by functional blocks to be described later. The RAM 203 also stores data that is desirable for the CPU 201 to carry out various processing sequences of the programs.

The programs to be executed by a computer may be recorded in the removable medium 221 as a package medium or the like and applied to use, for example. In this case, the programs can be installed in the storage section 213 through the input/output interface 210 when the removable medium 221 is attached to the drive 215.

The programs may also be provided through a wired or wireless transmission medium such as a local area network, the Internet, or a distal satellite broadcasting link. In this case, the programs can be received by the communication section 214 and installed in the storage section 213.

Alternatively, the programs may be pre-installed in the ROM 202 or the storage section 213.

### Functional Blocks of Telepresence Apparatus

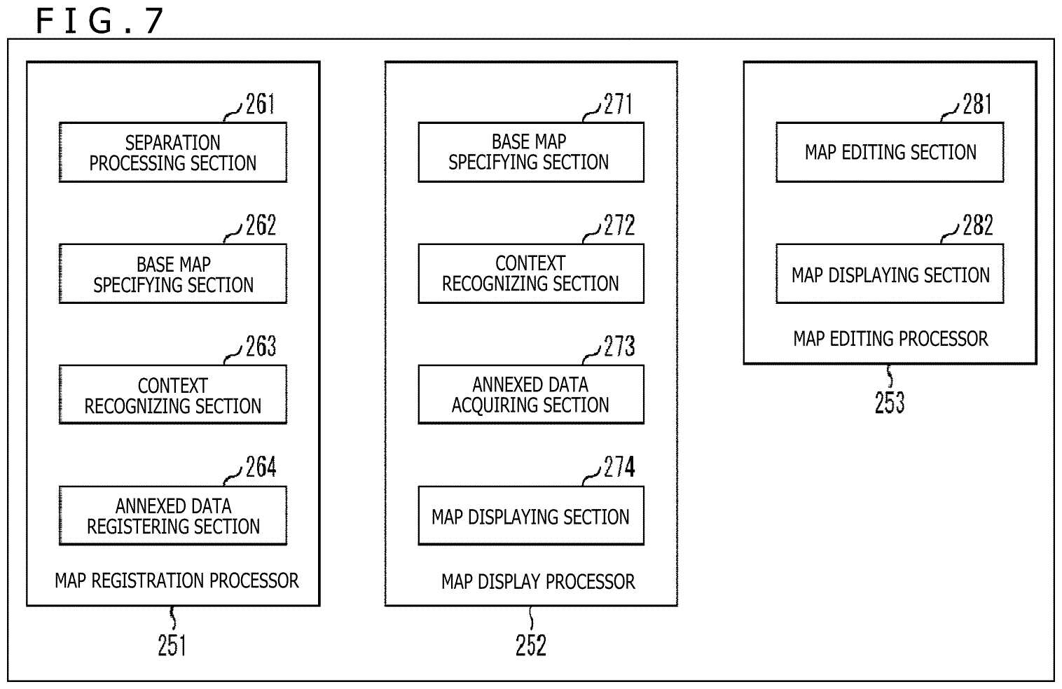

In the above telepresence apparatus 101, the CPU 201 executes the programs to realize the functions represented by the functional blocks illustrated in FIG. 7, for example. Specifically, the telepresence apparatus 101 includes, as the functional blocks, a map registration processor 251, a map display processor 252, and a map editing processor 253.

The map registration processor 251 performs a process regarding the registration of data in a map database that is a database for managing data regarding maps. The map display processor 252 performs a process regarding the display of maps registered in the map database. The map editing processor 253 performs a process regarding the editing of maps. Needless to say, these processors may include functions other than those described above.

The map registration processor 251 can include a separation processing section 261, a base map specifying section 262, a context recognizing section 263, and an annexed data registering section 264. Needless to say, the map registration processor 251 may include functional blocks other than those described above.

The separation processing section 261 separates a base map and annexed data annexed to the base map on the basis of information (e.g., a captured image) detected in the desktop area. The base map specifying section 262 performs a process regarding the specifying of a base map.

The context recognizing section 263 performs a process regarding the recognition of a context, such as the situation of the user, the situation of the production, or the purpose and application of the map, for example. The context recognizing section 263 can recognize a state at the time when annexed data is created and generate context information thereof, for example.

The annexed data registering section 264 performs a process regarding the registration of annexed data annexed to a base map in the map database. Needless to say, the above processing sections may include functions other than those described above.

The map display processor 252 can include a base map specifying section 271, a context recognizing section 272, an annexed data acquiring section 273, and a map displaying section 274. Needless to say, the map display processor 252 include functional blocks other than those described above.

The base map specifying section 271 performs a process regarding the specifying of a base map. The context recognizing section 272 performs a process regarding the recognition of a desired context. The annexed data acquiring section 273 performs a process regarding the acquisition of annexed data. The map displaying section 274 performs a process regarding the displaying of a map including annexed data, etc. Needless to say, the above processing sections may include functions other than those described above.

The map editing processor 253 can include a map editing section 281 and a map displaying section 282. Needless to say, the map editing processor 253 may include functional blocks other than those described above.

The map editing section 281 performs a process regarding the editing of a map. For example, the map editing section 281 may create annexed data and include context information created by the context recognizing section 263 in the created annexed data.

The map displaying section 282 performs a process regarding the displaying of a map. For example, the map displaying section 282 outputs annexed data read out from the map database, together with a base map, through the output section 212. Needless to say, the above processing sections may include functions other than those described above.

Needless to say, the telepresence apparatus 101 may include functional blocks other than those illustrated in FIG. 7.

### Configuration of Server

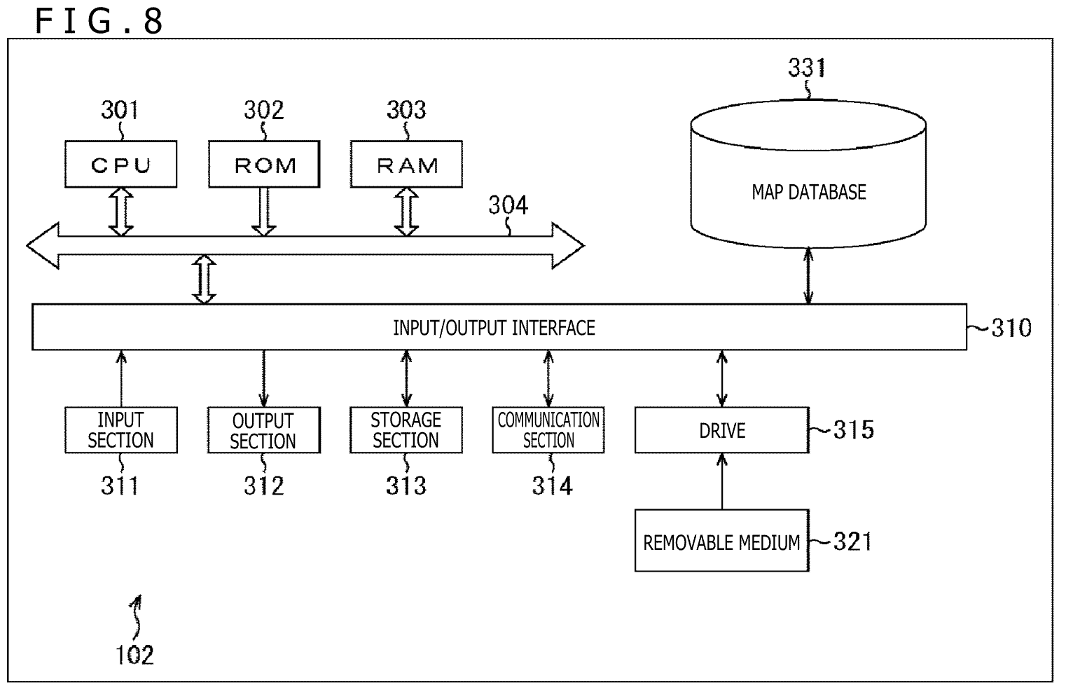

FIG. 8 illustrates, in block form, a major configurational example of the server 102. In the server 102 illustrated in FIG. 8, a CPU 301, a ROM 302, and a RAM 303 are connected to each other by a bus 304.

An input/output interface 310 is connected to the bus 304. An input section 311, an output section 312, a storage section 313, a communication section 314, and a drive 315 are connected to the input/output interface 310. A map database 331 is also connected to the input/output interface 310.

The input section 311 can include any input device such as a keyboard, a mouse, a microphone, a touch panel, a camera (image sensor), a motion sensor, and various other sensors, for example. The input section 311 may also include input terminals. The output section 312 can include any output device such as a display, a projector, or a speaker, for example. The output section 312 may also include output terminals.

The storage section 313 includes any storage medium such as a hard disk, a RAM disk, or a nonvolatile memory, for example, and a storage controller for writing information into and reading out information from the storage medium. The communication section 314 includes a network interface, for example. The drive 315 drives any removable medium 321 such as a magnetic disk, an optical disk, a magnetooptical disk, or a semiconductor memory to write information into and read out information from the removable medium 321.

The map database 331 stores and manages information regarding maps. For example, the map database 331 stores and manages annexed data annexed to base maps in relation to information regarding the base maps.

In the server 102 thus configured, the CPU 301 loads programs stored in the storage section 313 into the RAM 303 through the input/output interface 310 and the bus 304 and executes the loaded programs to realize various functions represented by functional blocks to be described later. The RAM 303 also stores data that is desirable for the CPU 301 to carry out various processing sequences of the programs.

The programs to be executed by a computer may be recorded in the removable medium 321 as a package medium or the like and applied to use, for example. In this case, the programs can be installed in the storage section 313 through the input/output interface 310 when the removable medium 321 is attached to the drive 315.

The programs may also be provided through a wired or wireless transmission medium such as a local area network, the Internet, or a distal satellite broadcasting link. In this case, the programs can be received by the communication section 314 and installed in the storage section 313.

Alternatively, the programs may be pre-installed in the ROM 302 or the storage section 313.

### Functional Blocks of Server

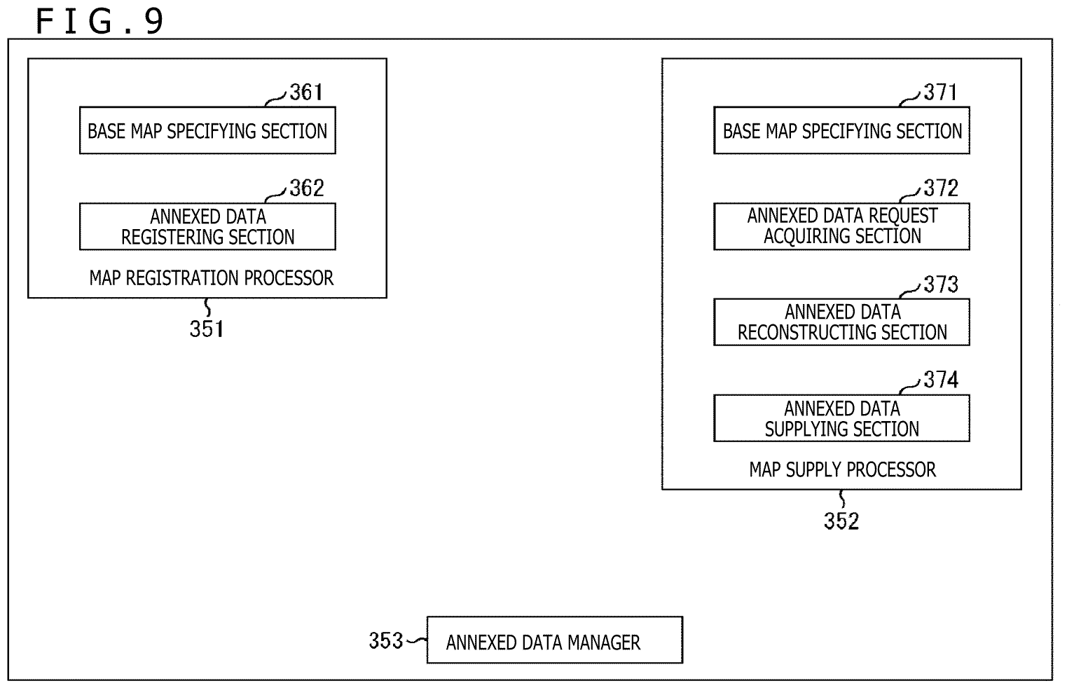

In the above server 102, the CPU 301 executes the programs to realize the functions represented by the functional blocks illustrated in FIG. 9, for example. Specifically, the server 102 includes, as the functional blocks, a map registration processor 351, a map supply processor 352, and an annexed data manager 353.

The map registration processor 351 performs a process regarding the registration of information in the map database 331. The map supply processor 352 performs a process regarding the supplying of information regarding maps.

The annexed data manager 353 performs a process regarding the management of information registered in the map database 331. Needless to say, these processors may include functions other than those described above.

The map registration processor 351 can include a base map specifying section 361 and an annexed data registering section 362. Needless to say, the map registration processor 351 may include functional blocks other than those described above.

The base map specifying section 361 performs a process regarding the specifying a base map to be processed. The annexed data registering section 362 performs a process regarding the registration of annexed data in the map database 331. The annexed data registering section 362 can associate annexed data annexed to a base map specified by the base map specifying section 361 with information regarding the base map, and register the annexed data in the map database 331 that is a database for managing data regarding maps. Further, the annexed data registering section 362 can acquire annexed data annexed to a base map specified by the base map specifying section 361 from the telepresence apparatus 101 through the communication section 314. Needless to say, these processing sections may include functions other than those described above.

The map supply processor 352 can include a base map specifying section 371, an annexed data request acquiring section 372, an annexed data reconstructing section 373, and an annexed data supplying section 374. Needless to say, the map supply processor 352 may include functional blocks other than those described above.

The base map specifying section 371 performs a process regarding the specifying of a base map. For example, the base map specifying section 371 can specify a base map to be processed. For example, the annexed data manager 353 can read out annexed data annexed to a base map specified by the base map specifying section 371 from the map database 331 that is a database for managing data regarding maps. Further, the annexed data manager 353 can read out, from the map database 331, annexed data including context information corresponding to a state recognized by the context recognizing section 263, among annexed data annexed to a base map specified by the base map specifying section 371.

The annexed data request acquiring section 372 performs a process regarding the acquisition of a request for annexed data supplied from the telepresence apparatus 101.

The annexed data reconstructing section 373 performs a process regarding the reconstruction of annexed data. For example, the annexed data reconstructing section 373 reconstructs annexed data to be annexed to a base map, by using annexed data read out from the map database 331 by the annexed data manager 353.

The annexed data supplying section 374 performs a process regarding the supplying of annexed data. For example, the annexed data supplying section 374 can supply annexed data read out by the annexed data manager 353. Needless to say, these processing sections may include functions other than those described above.

Needless to say, the server 102 may include functional blocks other than those illustrated in FIG. 9.

### Base Map

Not only digital map data but also physical maps such as paper maps, for example, may be used as base maps. In a case where a physical map is used as a base map, the user 121 places the map on the desktop area 152 of the telepresence apparatus 101 and has the projection detector 154 or the like detect the map.

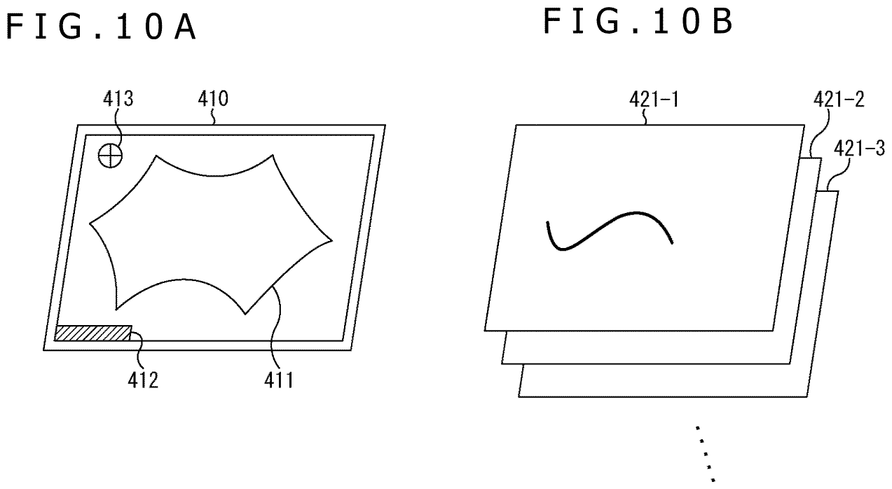

An example of a base map is illustrated in FIG. 10A. A base map 410 illustrated in FIG. 10A includes, in addition to map information 411, identification information 412 and a marker 413. The identification information 412 represents image information for identifying the base map and includes an ID represented by a character string of the like that can include characters, numbers, symbols, pictures, etc., and code information represented by a bar code, a two-dimensional code, or the like. The marker 413 represents image information indicative of an orientation.

The base map can be specified (distinguished from other maps) on the basis of the identification information 412, the marker 413, or map shapes (outlines) characters, etc., on the base map.

### Separating Process

In a case where a map is edited, the user 121 annexes information actually (physically) or virtually to the base map 410. In a case where the result of the work is to be registered (saved) in the map database 331, a separating process is carried out to separate the specified map data and the data input thereto (the annexed data). Then, as illustrated in FIG. 10B, pieces of the annexed data are classified according to types, on the basis of their contents, contexts, etc. In a case of FIG. 10B, the annexed data including annexed data 421-1, annexed data 421-2, annexed data 421-3, . . . is separated from the base map 410.

It is to be noted that, in a case where the annexed data 421-1 through the annexed data 421-3 do not need to be described separately from each other below, they are referred to as annexed data 421.

### Registration of Annexed Data

As described above, annexed data is separated on the basis of context information, etc., and registered as multidimensional data in the map database 331.

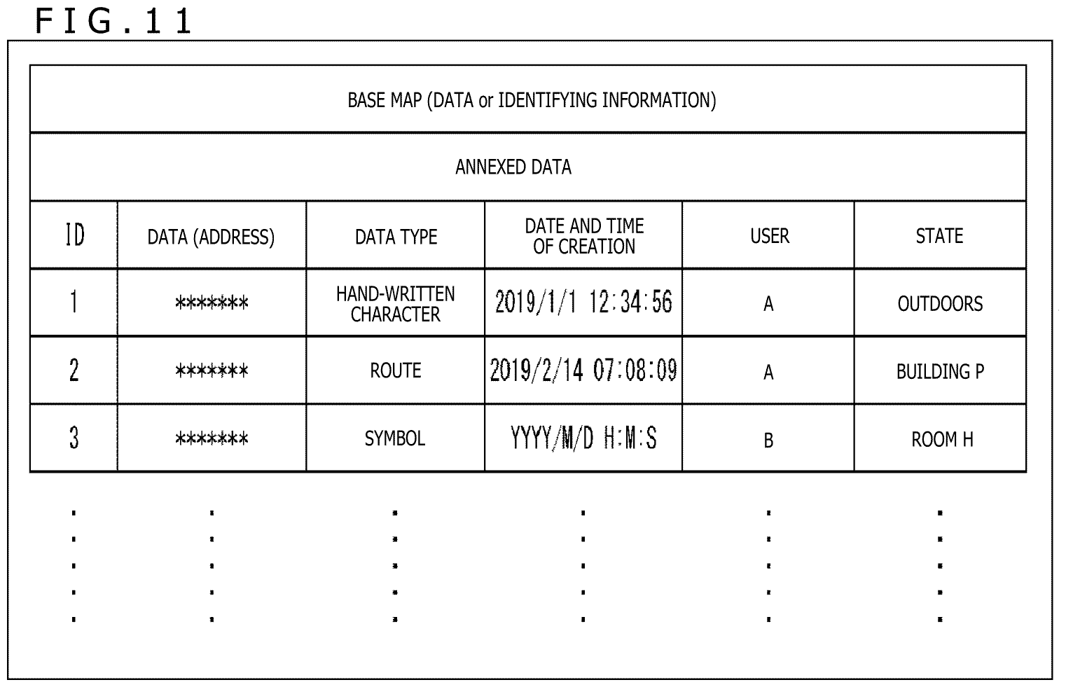

FIG. 11 illustrates a major configurational example of annexed data registered in the map database 331. As illustrated in FIG. 11, annexed data is registered in the map database 331 in linked relation to information regarding a base map.

Information regarding a base map may represent data of the base map or address information indicating the location of data of the base map. The data of the base map can include at least one of identification information, orientation, map shapes (outlines) characters, or the like on the base map, for example. In a case where the base map is represented by digital data, the data of the base map can include the map data. Needless to say, the information regarding the base map can include any information.

Further, annexed data includes at least one of ID, data (address), data type, date and time of creation, user, or state. The ID refers to information for identifying the annexed data. The data (address) refers to annexed data itself or information representing the location (address) where the annexed data is stored. The data type refers to information representing what the annexed data is like, e.g., “hand-written characters,” “route,” “symbol,” or the like. The date and time of creation refers to information representing the date and time when the annexed data is created (or updated). The user refers to information representing the user who has created the annexed data, e.g., “A,” “B,” or the like. The state refers to information representing the place, situation, or the like where the annexed data is created, e.g., “outdoors,” “building P,” “room H,” or the like.

Annexed data thus includes not only information annexed to a base map but also multidimensional context information. Annexed data is managed in the map database 331 by using the multidimensional context information.

Therefore, for displaying a map, the telepresence apparatus 101 can search for and display appropriate annexed data on the basis of context information. In other words, the telepresence apparatus 101 can search more easily for appropriate annexed data to be displayed on a map. Consequently, the telepresence apparatuses 101 allow users at remote places to work more easily together to produce a map.

### Process Regarding Registration of Annexed Data

The telepresence system 100 is assumed to use the telepresence apparatus 101 for interconnecting users at places remote from each other with natural communication as if the users were present in the same space. The telepresence system 100 has a function to express user's finger pointing actions and writing actions in a natural manner as if companion users were present across an actual table or desk while presenting life-size user images, bidirectional conversations of high sound quality, and atmosphere at the sites.

The sensors (scanners and cameras) included in the telepresence apparatus 101 dynamically (or statically) capture a “map” presented in a cooperative work space by a user with a scanning function. Map information as a base and hand-written information are separated from markers, codes, characters, map shapes (outlines), etc., included in the map while being checked against a cloud map database. The context recognizing function of the telepresence apparatus 101 analyzes when the annexed data has been created by whom in what situation and for what purpose. The annexed data thus analyzed is updated and integrated as multidimensional data in the database.

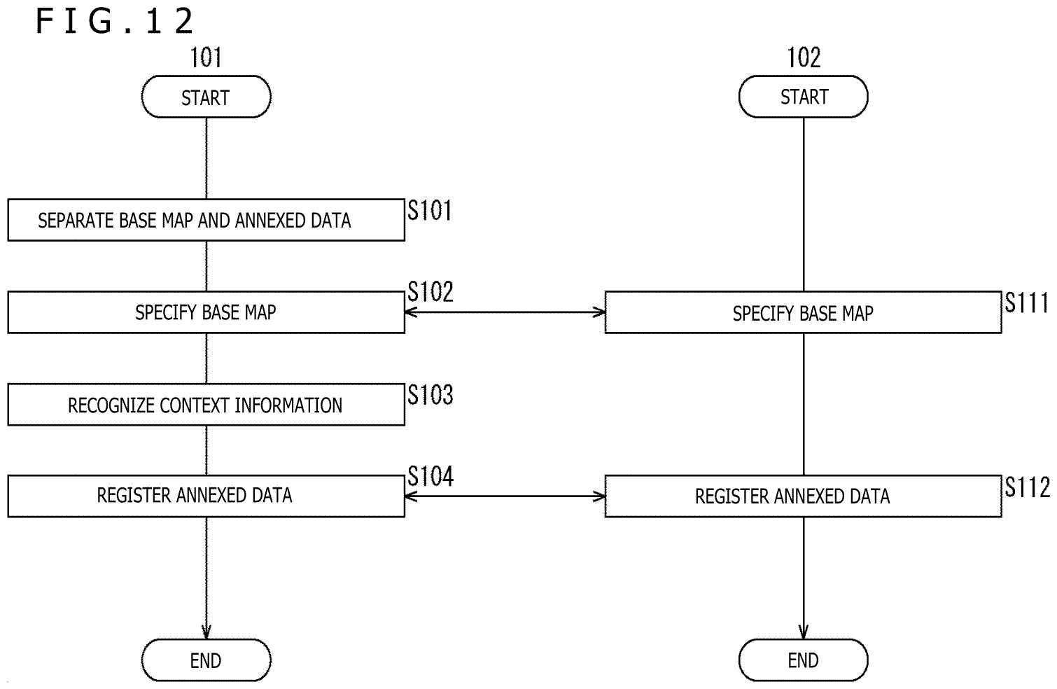

An example of a processing sequence carried out for registering such annexed data will be described below with reference to a flowchart illustrated in FIG. 12.

When users at places remote from each other edit a base map by using the telepresence apparatuses 101, the separation processing sections 261 of the telepresence apparatuses 101 separate the base map and annexed data from each other in step S101.

In step S102, the base map specifying sections 262 specify the base map in cooperation with the base map specifying section 271 of the server 102. In step S111, the base map specifying section 361 of the server 102 specifies the base map in cooperation with the base map specifying sections 262 of the telepresence apparatuses 101.

For example, the base map specifying sections 262 acquire information of the base map to be edited (e.g., identification information, markers, outlines, etc.) through the input sections 211 (the projection detectors 154, etc.) and supply the acquired information through the communication sections 214 to the base map specifying section 361. When the base map specifying section 361 acquires the information via the communication section 314, the base map specifying section 361 checks the information against the map database 331. In a case where a base map corresponding to the information is registered in the map database 331, that is, in a case where an edited base map is registered in the map database 331, then the base map specifying section 361 sends a notice of that effect to the base map specifying sections 262 via the communication section 314. The base map specifying sections 262 acquire the notice via the communication sections 214.

Further, in a case where a base map corresponding to the information is not registered in the map database 331, that is, in a case where an edited base map is not registered in the map database 331, then the base map specifying section 361 registers a base map corresponding to the information in the map database 331. The base map specifying section 361 then sends a notice of that effect to the base map specifying sections 262 via the communication section 314. The base map specifying sections 262 acquire the notice via the communication sections 214.

In step S103, the context recognizing sections 263 recognize a state at the time when annexed data is created, e.g., the situation of the users, the situation of the production, the purpose and application of the map, etc., and create context information. The context recognizing sections 263 include the created context information in the annexed data separated in step S101.

In step S104, the annexed data registering sections 264 supply the annexed data via the communication sections 214 to the server 102 in which the annexed data is registered in the map database 331.

The annexed data registering section 362 of the server 102 acquires the annexed data via the communication section 314 in step S112. Then, the annexed data registering section 362 supplies the acquired annexed data to the map database 331, registering the annexed data in association with the base map specified in step S111.

By thus carrying out the processing sequence, the users can more easily register the edited result as annexed data in association with the base map in the map database 331.

### Process Regarding Displaying of Annexed Data

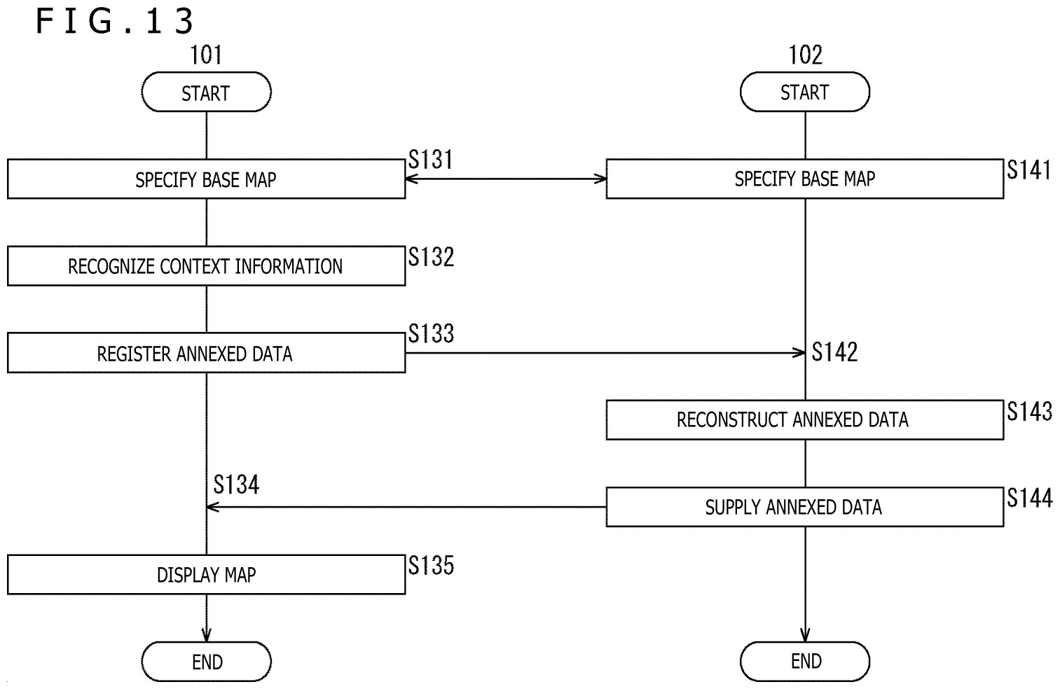

The annexed data thus registered can freely be called and superposed by setting a desirable scene, application, and purpose (by way of projection mapping, AR superposition, new printing, transmissive display, or the like). A processing sequence with respect to the displaying of such annexed data will be described below with reference to a flowchart illustrated in FIG. 13.

When the processing sequence is started, the base map specifying sections 271 of the telepresence apparatuses 101 specify a base map in cooperation with the base map specifying section 371 of the server 102 in step S131. In step S141, the base map specifying section 371 of the server 102 specifies a base map in cooperation with the base map specifying sections 271 of the telepresence apparatuses 101.

For example, when the user of one of the telepresence apparatuses 101 places a base map on the desktop area, the base map specifying section 271 acquires information (e.g., identification information, markers, outlines, etc.) of the base map through the input section 211 (the projection detector 154 or the like). Then, the base map specifying section 271 supplies the acquired information via the communication section 214 to the base map specifying section 371.

When the base map specifying section 371 of the server 102 acquires the information via the communication section 314, the base map specifying section 371 checks the information against the map database 331. In a case where a base map corresponding to the information is registered in the map database 331, that is, in a case where the base map placed on the desktop area is registered in the map database 331, then the base map specifying section 371 sends a notice of that effect via the communication section 314 to the base map specifying section 271. The base map specifying section 271 acquires the notice via the communication section 214.

Further, in a case where a base map corresponding to the information supplied by the base map specifying section 271 is not registered in the map database 331, that is, in a case where the base map placed on the desktop area is not registered in the map database 331, then the base map specifying section 371 sends a notice of that effect via the communication section 314 to the base map specifying section 271. The base map specifying section 271 acquires the notice via the communication section 214. In this case, since annexed data corresponding to the base map placed on the desktop area is not registered in the map database 331, a request for the annexed data is omitted, and the processing sequence comes to an end.

In a case where annexed data corresponding to the base map placed on the desktop area is registered in the map database 331, the context recognizing section 272 recognizes a state at the time when annexed data is created, such as the situation of the user, the situation of the production, or the purpose and application of the map, for example, and generates context information in step S132.

Then, in step S133, the context recognizing section 272 supplies the created context information via the communication section 214 to the server 102, giving a request for annexed data.

The annexed data request acquiring section 372 of the server 102 acquires the request via the communication section 314 in step S142. The annexed data manager 353 reads out annexed data corresponding to the context information included in the request, among annexed data corresponding to the specified base map, from the map database 331.

In step S143, the annexed data reconstructing section 373 reconstructs annexed data by using the information read out from the map database 331.

In step S144, the annexed data supplying section 374 supplies the reconstructed annexed data via the communication section 314 to the telepresence apparatus 101 as a request source.

In step S134, the annexed data acquiring section 273 acquires the annexed data via the communication section 214.

In step S135, the map displaying section 274 displays a map that reflects the annexed data. Specifically, the map displaying section 274 projects the acquired annexed data onto the base map placed on the desktop area, by using the output section 212 (e.g., the projection detector 154). The annexed data is thus reflected in the base map.

The processing sequence thus carried out allows the user to more easily select annexed data corresponding to the context (the purpose and application, the state, etc.) and reflect the annexed data in the base map. Therefore, the user can more easily specify desired information from a variety of information and reflect the specified desired information in the base map. Accordingly, users at remote places can work more easily together to produce a map.

### Process Regarding Editing of Map

The map thus displayed can be edited or otherwise processed by users at remote places who work together. A function to scan, analyze, and integrate a series of “map” data can be used by each of the terminals connected together in a telepresence manner, allowing the users of the terminals to confirm (browse), edit, and produce a map bidirectionally on a real time basis.

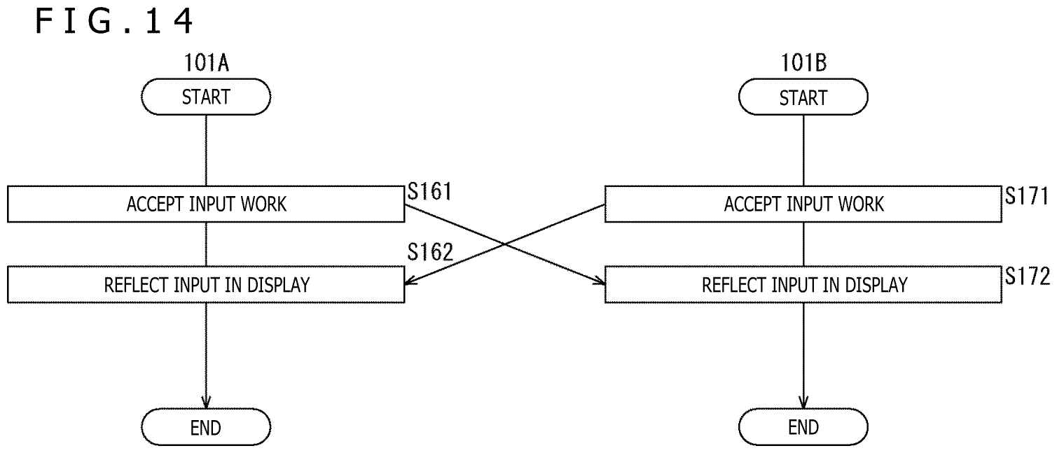

An example of a processing sequence of the editing of a map will be described below with reference to a flowchart illustrated in FIG. 14. Incidentally, in the example of FIG. 14, it is assumed that the telepresence apparatus 101A and the telepresence apparatus 101B communicate with each other, and their users work together to produce a map.

In step S161, the map editing section 281 of the telepresence apparatus 101A accepts input work from the user 121A or the like to a base map, annexed data, etc., via the input section 211. The map editing section 281 supplies information, etc., regarding the result of map editing work corresponding to the input work via the communication section 214 to the telepresence apparatus 101B.

Similarly, in step S171, the map editing section 281 of the telepresence apparatus 101B accepts input work from the user 121B or the like to a base map, annexed data, etc., via the input section 211. The map editing section 281 supplies information, etc., regarding the result of map editing work corresponding to the input work via the communication section 214 to the telepresence apparatus 101A.

In step S162, the map displaying section 282 of the telepresence apparatus 101A reflects the result of map editing work performed by the user 121A or the like of the telepresence apparatus 101A in step S161, in a map that is being displayed on or projected onto the desktop area via the output section 212. In other words, the map displaying section 282 reflects the result of map editing work performed in step S161 in annexed data projected onto the base map placed on the desktop area, for example.

Further, the map displaying section 282 of the telepresence apparatus 101A acquires information regarding the map editing work performed by the user 121B or the like and supplied from the telepresence apparatus 101B in step S171 via the communication section 214. Then, on the basis of the acquired information, the map displaying section 282 reflects the result of map editing work performed by the user 121B or the like of the telepresence apparatus 101B, in a map that is being displayed on or projected onto the desktop area via the output section 212. In other words, the map displaying section 282 reflects the result of map editing work performed in step S171 in annexed data projected onto the base map placed on the desktop area, for example.

In step S172, the map displaying section 282 of the telepresence apparatus 101B reflects the result of map editing work performed by the user 121B or the like of the telepresence apparatus 101B in step S171, in a map that is being displayed on or projected onto the desktop area via the output section 212. In other words, the map displaying section 282 reflects the result of map editing work performed in step S171 in annexed data projected onto the base map placed on the desktop area, for example.

Further, the map displaying section 282 of the telepresence apparatus 101B acquires information regarding the map editing work performed by the user 121A or the like and supplied from the telepresence apparatus 101A in step S161 via the communication section 214. Then, on the basis of the acquired information, the map displaying section 282 reflects the result of map editing work performed by the user 121A or the like of the telepresence apparatus 101A, in a map that is being displayed on or projected onto the desktop area via the output section 212. In other words, the map displaying section 282 reflects the result of map editing work performed in step S161 in annexed data projected onto the base map placed on the desktop area, for example.

The processing sequence thus carried out allows the users at the remote places to work more easily together to produce a map.

By using the telepresence system 100 described above, a user can share a base map with another user at a connected remote place through the telepresence apparatus 101 and can confirm, edit, and produce the base map comfortably and efficiently by way of natural cognition, action, and communication as if the users were in the same space.

### 2. Second Embodiment

### Use Case

Users at places that are remote from each other are assumed to view combinations of “maps” in particular areas (2D/3D+chronological maps) in various formats including paper maps, digital maps on tablet terminals, 3D-model maps, etc., for example.

### In a Case Where Base Points Have Maps in One Format

In a case where base points have maps in one format, since the maps have the largest amount of information and have precise map data shared, only hand-written information and updating information that have been added by users and differential information due to version differences or the like may be displayed by way of projection mapping or AR superposition on the respective maps or may be displayed on displays for respective original base maps. In this manner, it is possible for the users to work bidirectionally on a real time basis.

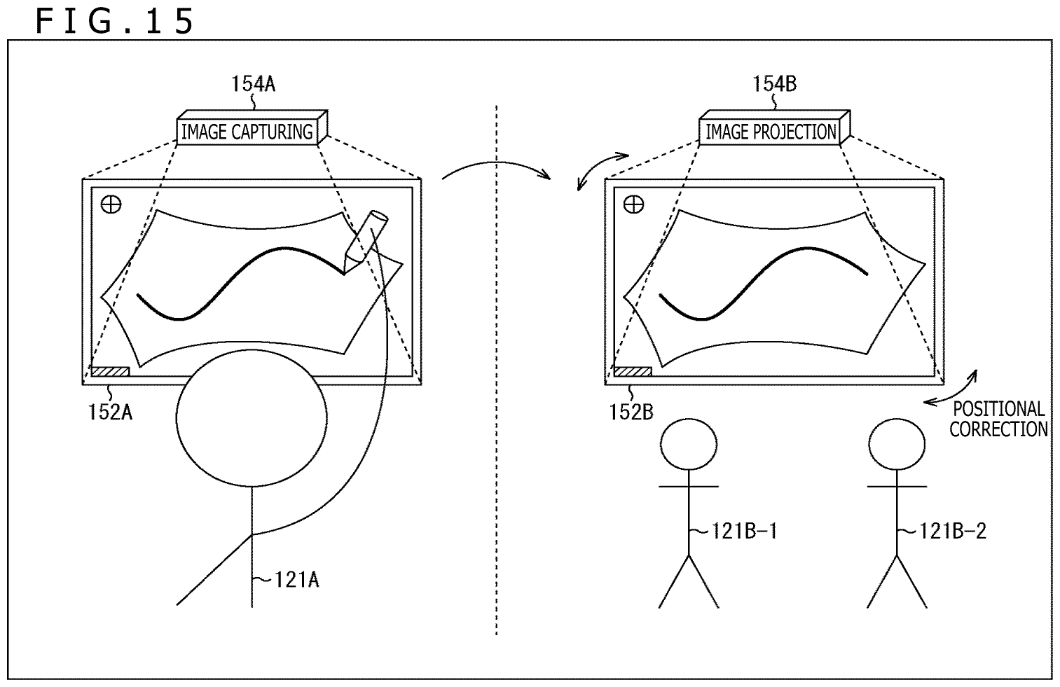

For example, in a case where base maps are made of paper and annexed data is to be projected onto the base maps of paper, as illustrated in FIG. 15, information written at a spot A by the user 121A is displayed dynamically in superposed relation to a corresponding point at a spot B on the base map viewed by the user 121B.

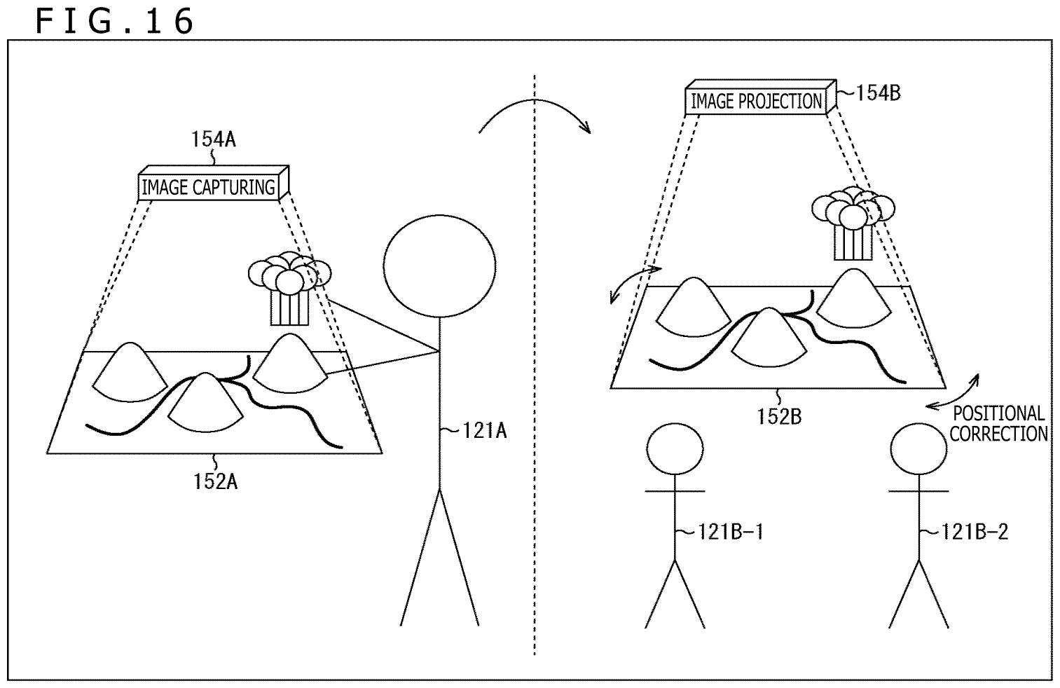

Further, in a case where annexed data is to be projected onto a 3D-model base map, as illustrated in FIG. 16, when the user 121A applies a feature (either real or virtual) resembling an eruption to a mountain system on the 3D-model map, the feature is projection-mapped in a 2D or 3D fashion and displayed dynamically in superposed relation to a corresponding point at a spot B on the base map viewed by the user 121B. The user 121B can then act (by way of an education activity or the like) on the displayed feature with a material such as clay in cooperative work with the user 121A, for example.

According to modern geology or geopark learning, education is given on the basis of information of 2D video and books. The telepresence connection that is bidirectional on a real time basis as illustrated allows the users to share a seamless learning experience and spatial image by placing stone, sand, mud, plants, animals, etc., at local sites on both of the desktop areas against an actual scene, geometrical features, an environment, and a 3D landscape.

### Applications

By using the telepresence system 100 between a plurality of geopark sites, children and residents can interact with new companion users in lessons and workshops on the basis of information regarding places that are different from time to time, and therefore, they can feel lively and pleasant and are likely to keep highly motivated.

Further, the telepresence system 100 can not only present most attractive sunset scenes and rare meteorological phenomena that are likely to occur at sightseeing spots and scenic spots, but also effectively give multimedia presentations of real-time situations including good and bad weather days, dynamic rendering such as time-lapse (high-speed playback), or images in combination with acoustic data.

Further, the telepresence system 100 allows the users to experience a plurality of cases to know their land (native place), and also to have a high-level experience of learning, for example, features common or related to other lands or geographical features and cultural tendencies and effects that geological features may produce.

Moreover, the telepresence system 100 is assumed to improve the quality of the relationship between participating users through a series of activities and interactions and to produce creative actions and projects, and can be used as a system for getting people to meet each other and matching social activities by integrating user communities and projects as meta information in a broad sense with a map database.

### In a Case Where Base Points Have Maps in Different Formats

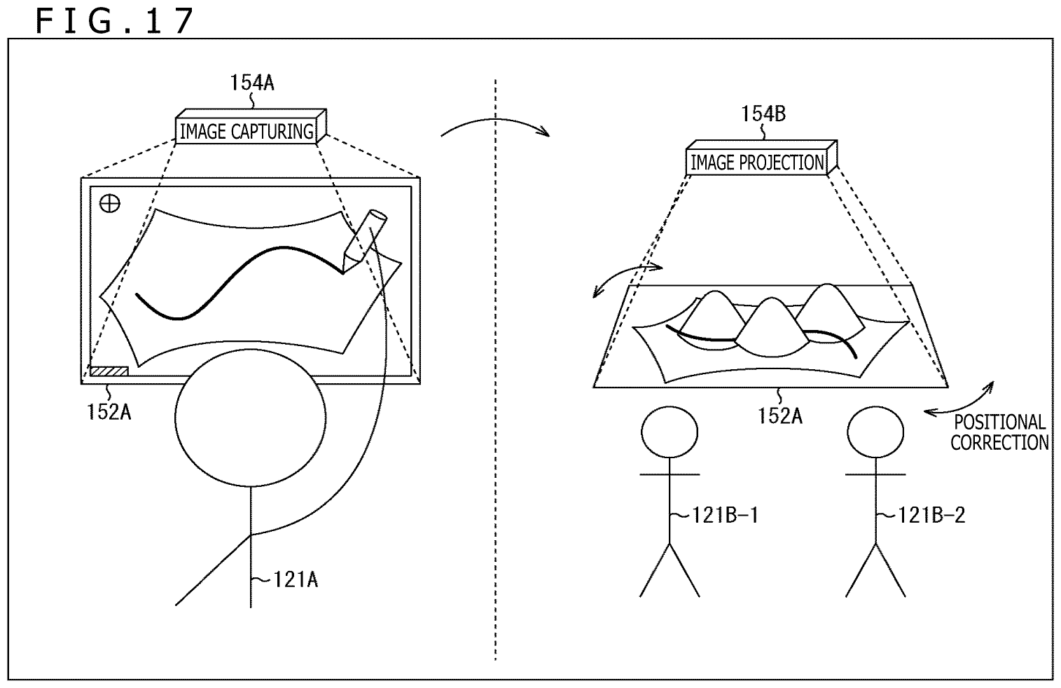

In a case where one telepresence apparatus is to process a 2D paper base map and the other telepresence apparatus is to process a 3D-model base map, as illustrated in FIG. 17, for example, information written into the 2D paper base map at a spot A by the user 121A can be converted into data at a spot B in the 3D-model base map viewed by the user 121B and presented as shared information in the corresponding spot B.

In a case where users at places that are remote from each other have maps in different formats, the telepresence system 100 can present optimum data into which map database information having high-level meta information is converted with respect to the different formats.

### 3. Appendix

### Management of Map By Telepresence Apparatus

The server 102 has been illustrated as managing maps in the above description. However, the telepresence apparatus 101 may manage maps. Specifically, the telepresence apparatus 101 may have the map database 331 and may realize the functions of the annexed data manager 353.

### Items to Which Present Technology is Applicable

The present technology is applicable to any arrangement.

For example, the present technology is applicable to various electronic devices such as transmitters and receivers (e.g., television receivers and cellular phones) for use in satellite broadcasting services, wired broadcasting services such as cable TV, distribution services on the Internet, distribution services for terminals by way of cellular communication, and the like, or devices (e.g., hard disk recorders and cameras) for recording images in storage media including optical disks, magnetic disks, flash memories, and the like and reproducing images from such storage media.

Further, for example, the present technology can be implemented as part of devices such as processors (e.g., video processors) as system large-scale integration (LSI) circuits, modules (e.g., video modules) using a plurality of processors, units (e.g., video units) using a plurality of modules, sets (e.g., video sets) that include the units with other functions added thereto, or the like.

Moreover, the present technology is also applicable to a network system including a plurality of apparatuses, for example. The present technology may be implemented at a cloud computing system where tasks can be shared and processed together by a plurality of apparatuses through a network, for example. The present technology may be implemented by cloud services that provide services regarding images (moving images) to any terminal such as computers, audio visual (AV) devices, portable information processing terminals, or Internet-of-Things (IoT) devices.

It should be noted that, in the present description, a system refers to a set of multiple components (apparatuses, modules (parts), or the like) where it does not matter whether or not all the components are housed in one casing. Therefore, a plurality of apparatuses that is housed in separate casings and connected together by a network, and an apparatus including a plurality of modules housed in one casing are both referred to as systems.

The processing sequences described above may be executed by hardware or software. In a case where a processing sequence is to be executed by software, a program included in the software is installed in a computer. Here, the computer includes a computer incorporated in dedicated hardware or a general-purpose personal computer, for example, that can perform various functions by installing various programs.

### Others

Embodiments of the present technology are not limited to the embodiments described above, and various changes and modifications may be made therein without departing from the scope of the present technology.

For example, an arrangement described as one apparatus (or processor) may be divided and constructed as a plurality of apparatuses (or processors). Conversely, arrangements described as a plurality of apparatuses (or processors) may be put together and constructed as one apparatus (or processor). Further, needless to say, arrangements other than those described above may be annexed to an arrangement as each apparatus (or each processor). In addition, part of an arrangement described as an apparatus (or processor) may be included in another apparatus (or another processor), provided it is substantially identical in arrangement and operation as an overall system.

Further, the programs described above may be executed by any apparatus. In such a case, it is sufficient that the apparatus has desirable functions (functional blocks or the like) and is able to obtain desirable information.

Further, the steps of a flowchart may be executed by one apparatus or may be shared by a plurality of apparatuses. In a case where a plurality of processes is included in one step, the processes may be executed by one apparatus or may be shared by a plurality of apparatuses. Stated otherwise, the plurality of processes included in one step may be executed as processes of a plurality of steps. Conversely, processes described as a plurality of steps may be executed together as one step.

Further, with respect to a program to be executed by a computer, for example, the processes of steps that describe the program may be executed chronologically in the order described in the present description or in parallel or may be executed individually at desirable timings when they are called or the like. In other words, the processes of the steps may be executed in an order different from the above order unless there is any inconsistency therebetween. In addition, the processes of steps that describe the program may be executed parallel to processes of another program or may be executed in combination with processes of another program.

Further, a plurality of technologies relating to the present technology may be implemented independently of each other unless there is any inconsistency therebetween, for example. Needless to say, a plurality of desirable technologies may be implemented in combination therewith. For example, part or all of the present technology described in any one of the embodiments may be implemented in combination with part or all of the present technology described in another embodiment. Moreover, part or all of the present technology described above may be implemented in combination with another technology not described above.

It should be noted that the present technology may take the following arrangements.

### 1

An information processing apparatus including:

a specifying section that specifies a base map to be processed; and

a registering section that associates annexed data annexed to the base map specified by the specifying section with information regarding the base map and registers the annexed data in a map database including a database that manages data regarding maps.

### 2

The information processing apparatus according to (1),

in which the annexed data includes at least one of written data written in the base map, address information indicating a location of the written data, data of map information added to the base map, address information indicating a location of the data of the map information, data of updating information for updating information included in the base map, or address information indicating a location of the data of the updating information.

### 3

The information processing apparatus according to (2),

in which the annexed data further includes context information indicating a state at a time when the annexed data is created.

### 4

The information processing apparatus according to (3),

in which the context information includes at least one of information regarding a type of the annexed data, information regarding a date and time of creation of the annexed data, information regarding a user who has created the annexed data, or information regarding the state at the time of creation of the annexed data.

### 5

The information processing apparatus according to (3), further including:

a context information creating section that recognizes the state at the time when the annexed data is created and generates the context information.

### 6

The information processing apparatus according to (5),

in which the annexed data is created, and the context information created by the context information creating section is included in the annexed data.

### 7

The information processing apparatus according to (1),

in which the information regarding the base map includes data of the base map or address information indicating a location of the base map.

### 8

The information processing apparatus according to (1), further including:

an acquiring section that acquires annexed data supplied from another apparatus,

in which the registering section associates the annexed data acquired by the acquiring section with the information regarding the base map specified by the specifying section and registers the annexed data in the map database.

### 9

The information processing apparatus according to (1), further including:

the map database.

### 10

An information processing method including:

specifying a base map to be processed; and

associating annexed data annexed to the base map that is specified with information regarding the base map and registering the annexed data in a map database including a database that manages data regarding maps.

### 11

An information processing apparatus including:

a specifying section that specifies a base map to be processed; and

a reading section that reads out annexed data annexed to the base map specified by the specifying section, from a map database including a database that manages data regarding maps.

### 12

The information processing apparatus according to (11),

in which the annexed data includes at least one of written data written in the base map, address information indicating a location of the written data, data of map information added to the base map, address information indicating a location of the data of the map information, data of updating information for updating information included in the base map, or address information indicating a location of the data of the updating information.

### 13

The information processing apparatus according to (12),

in which the annexed data further includes context information indicating a state at a time when the annexed data is created, and

the reading section reads out the annexed data including the desired context information, among the annexed data annexed to the base map specified by the specifying section, from the map database.

### 14

The information processing apparatus according to (13),

in which the context information includes at least one of information regarding a type of the annexed data, information regarding a date and time of creation of the annexed data, information regarding a user who has created the annexed data, or information regarding the state at the time of creation of the annexed data.

### 15

The information processing apparatus according to (13), further including:

a reconstructing section that reconstructs annexed data to be annexed to the base map, by using the annexed data read out by the reading section.

### 16

The information processing apparatus according to (13), further including:

a recognizing section that recognizes a state,

in which the reading section reads out the annexed data including the context information corresponding to the state recognized by the recognizing section, among the annexed data annexed to the base map specified by the specifying section, from the map database.

### 17

The information processing apparatus according to (11), further including:

a supplying section that supplies the annexed data read out by the reading section.

### 18

The information processing apparatus according to (11), further including:

an output section that outputs the annexed data read out by the reading section together with the base map.

### 19

The information processing apparatus according to (11), further including:

the map database.

### 20

An information processing method including:

specifying a base map to be processed; and

reading out annexed data annexed to the base map that is specified, from a map database including a database that manages data regarding maps.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a specifying section that specifies a base map to be processed; and
a registering section that associates annexed data annexed to the base map specified by the specifying section with information regarding the base map and registers the annexed data in a map database including a database that manages data regarding maps.

2. The information processing apparatus according to claim 1,
wherein the annexed data includes at least one of written data written in the base map, address information indicating a location of the written data, data of map information added to the base map, address information indicating a location of the data of the map information, data of updating information for updating information included in the base map, or address information indicating a location of the data of the updating information.

3. The information processing apparatus according to claim 2,
wherein the annexed data further includes context information indicating a state at a time when the annexed data is created.

4. The information processing apparatus according to claim 3,
wherein the context information includes at least one of information regarding a type of the annexed data, information regarding a date and time of creation of the annexed data, information regarding a user who has created the annexed data, or information regarding the state at the time of creation of the annexed data.

5. The information processing apparatus according to claim 3, further comprising:
a context information creating section that recognizes the state at the time when the annexed data is created and generates the context information.

6. The information processing apparatus according to claim 5,
wherein the annexed data is created, and the context information created by the context information creating section is included in the annexed data.

7. The information processing apparatus according to claim 1,
wherein the information regarding the base map includes data of the base map or address information indicating a location of the base map.

8. The information processing apparatus according to claim 1, further comprising:
an acquiring section that acquires annexed data supplied from another apparatus,
wherein the registering section associates the annexed data acquired by the acquiring section with the information regarding the base map specified by the specifying section and registers the annexed data in the map database.

9. The information processing apparatus according to claim 1, further comprising:
the map database.

10. An information processing method comprising:
specifying a base map to be processed; and
associating annexed data annexed to the base map that is specified with information regarding the base map and registering the annexed data in a map database including a database that manages data regarding maps.

11. An information processing apparatus comprising:
a specifying section that specifies a base map to be processed; and
a reading section that reads out annexed data annexed to the base map specified by the specifying section, from a map database including a database that manages data regarding maps.

12. The information processing apparatus according to claim 11,
wherein the annexed data includes at least one of written data written in the base map, address information indicating a location of the written data, data of map information added to the base map, address information indicating a location of the data of the map information, data of updating information for updating information included in the base map, or address information indicating a location of the data of the updating information.

13. The information processing apparatus according to claim 12,
wherein the annexed data further includes context information indicating a state at a time when the annexed data is created, and
the reading section reads out the annexed data including the desired context information, among the annexed data annexed to the base map specified by the specifying section, from the map database.

14. The information processing apparatus according to claim 13,
wherein the context information includes at least one of information regarding a type of the annexed data, information regarding a date and time of creation of the annexed data, information regarding a user who has created the annexed data, or information regarding the state at the time of creation of the annexed data.

15. The information processing apparatus according to claim 13, further comprising:
a reconstructing section that reconstructs annexed data to be annexed to the base map, by using the annexed data read out by the reading section.

16. The information processing apparatus according to claim 13, further comprising:
a recognizing section that recognizes a state,
wherein the reading section reads out the annexed data including the context information corresponding to the state recognized by the recognizing section, among the annexed data annexed to the base map specified by the specifying section, from the map database.

17. The information processing apparatus according to claim 11, further comprising:
a supplying section that supplies the annexed data read out by the reading section.

18. The information processing apparatus according to claim 11, further comprising:
an output section that outputs the annexed data read out by the reading section together with the base map.

19. The information processing apparatus according to claim 11, further comprising:
the map database.

20. An information processing method comprising:
specifying a base map to be processed; and
reading out annexed data annexed to the base map that is specified, from a map database including a database that manages data regarding maps.
